(19) United States
(12) Patent Application Publication
(10) Pub. No.: US 2023/0161423 A1
(43) Pub. Date: May 25, 2023

(54) JOYSTICK

(71) Applicant: JOWUA INTERNATIONAL LIMITED, George Hill (AI)

(72) Inventors: CHENG-SU HUANG, Taipei City (TW); CHENG-WEN HUANG, Taipei City (TW); CHUANG-CHENG CHIU, Taipei City (TW)

(21) Appl. No.: 17/534,669

(22) Filed: Nov. 24, 2021

(51) Int. Cl. G06F 3/0338; A63F 13/22; G06F 3/02

(52) U.S. Cl. CPC G06F 3/0338; A63F 13/22; G06F 3/0202; A63F 2300/1018

(57) ABSTRACT

A joystick includes a switching module, an alignment module and a button group. The switching module is used to receive a switching instruction from a user. The alignment module is coupled to the switching module, and an alignment sub-module within the alignment module is activated according to the switching instruction. The button group is coupled to the alignment module. The button group is adjusted to a specific state according to the activated alignment sub-module. In this way, the joystick can realize one-to-many application scenarios to meet various user needs.

### FIELD OF THE DISCLOSURE

The present invention relates to a joystick.

### BACKGROUND

In the current social development situation, it has become a common practice for people to use joysticks to play mobile games, console games, and games on car systems. However, different types of joysticks have different button distributions and different functions. For example, the joysticks for playing Switch games and PS4 games have different functions. The resulting problem is that different joysticks must be used for different games or devices, which is quite troublesome.

Therefore, the present invention provides a joystick to solve the problems described above.

### SUMMARY

The purpose of the present invention is to provide a joystick that can realize one-to-many application scenarios and meet various user needs.

In order to achieve at least one of the advantages or other advantages, an embodiment of the present invention provides a joystick, which includes a switching module, an alignment module, and a button group.

The switching module is used to receive a switching instruction from a user. The alignment module is coupled to the switching module, and the alignment sub-module within the alignment module is activated according to the switching instruction. The button group is coupled to the alignment module and adjusted to a specific state according to the activated alignment sub-module.

In some embodiments, the alignment module includes a first alignment sub-module, a second alignment sub-module, a third alignment sub-module and a fourth alignment sub-module. The first alignment sub-module, the second alignment sub-module, the third alignment sub-module and the fourth alignment sub-module are independent with each other. According to the switching instruction, the alignment module activates one of the first alignment sub-module, the second alignment sub-module, the third alignment sub-module and the fourth alignment sub-module corresponding to the switching instruction.

In some embodiments, the first alignment sub-module, the second alignment sub-module, the third alignment sub-module and the fourth alignment sub-module correspond to different modes.

In some embodiments, the first alignment sub-module corresponds to a first Bluetooth channel mode, the second alignment sub-module corresponds to a second Bluetooth channel mode, the third alignment sub-module corresponds to a Switch series mode and the fourth alignment sub-module corresponds to a shutdown mode.

In some embodiments, the alignment module further includes a fifth alignment sub-module corresponding to a PS series mode.

In some embodiments, the switching module receives the switching instruction through a lever or a click.

In some embodiments, the specific state refers to displaying a button corresponding to the activated alignment sub-module.

In some embodiments, the joystick may further include a battery module coupled to the button group for providing power.

Therefore, with the joystick provided by the present invention, one-to-many application scenarios can be realized by the combination of the switch module, the alignment module and the button group, that is, one joystick can support such as the use of Tesla in-vehicle systems, Apple devices, Xbox devices, Switch games and other different scenarios meet the various needs of users.

The foregoing description is merely an overview of the technical solution of the present invention. In order to enable a clearer understanding of the technical means of the present invention, and thus it can be implemented in accordance with the teachings of the present invention, and to enable the above features and advantages of the present invention to be more clearly understood, the embodiments are described in detail with reference to the accompanying drawings.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a schematic structural diagram of the joystick of the present invention.

### DETAILED DESCRIPTION OF PREFERRED EMBODIMENTS

It should be noted, the embodiments illustrated herein are applied for explaining rather than limiting the present invention.

The specific structural and functional details disclosed herein are only representative and are intended for describing exemplary embodiments of the disclosure. However, the disclosure can be embodied in many forms of substitution and should not be interpreted as merely limited to the embodiments described herein.

In the description of the present invention, the terms for indicating orientations or positional relationships such as “center”, “longitudinal direction”, “above”, “below”, “left”, “right”, “vertical”, “horizontal”, “top”, “bottom”, “inside” and “outward” for indicating orientations or positional relationships refer to orientations or positional relationships as shown in the drawings; the terms are for the purpose of illustrating the disclosure and simplifying the description rather than indicating or implying the device or element must have a certain orientation and be structured or operated by the certain orientation, and therefore cannot be regarded as limitation with respect to the disclosure. In addition, the terms as “ first” and “ second” are used for describing purpose and cannot be interpreted as the instruction or hint about the importance nor be implied the quantity of characteristic elements. Thus, the feature limited with “first” or “second” may include one or more characteristic element. In description of the present invention, the implication of “multiple” is two or more unless otherwise indicated. Further, the terms “comprises,” “comprising,” or any other variation thereof, are intended to cover a non-exclusive inclusion.

In this invention, unless otherwise clearly defined and limited, the terms such as “installation”, “being connected” and “connection” should be interpreted broadly, such as, can be fixedly connected with, also can be removably connected, or connected in one piece; and can be mechanically connected, also can be electrically connected; can be directly connected, also can be indirectly connected; can be connected by intermedia; can be the connection of two element internally. For the ordinary skilled in the art, the actual meaning of above-mentioned term in the present invention can be understood according to the specific situations.

The terms used herein are only for describing specific embodiments and are not intended to limit the exemplary embodiments. Unless the context clearly dictates otherwise, the singular forms such as “a” and “one” used herein are also intended to include the plural. It should also be understood that the terms “including” and/or “comprising” used herein specify the existence of the stated features, integers, steps, operations, units and/or components, and do not exclude the existence or addition of one or more other features, integers, steps, operations, units, components, and/or combinations thereof.

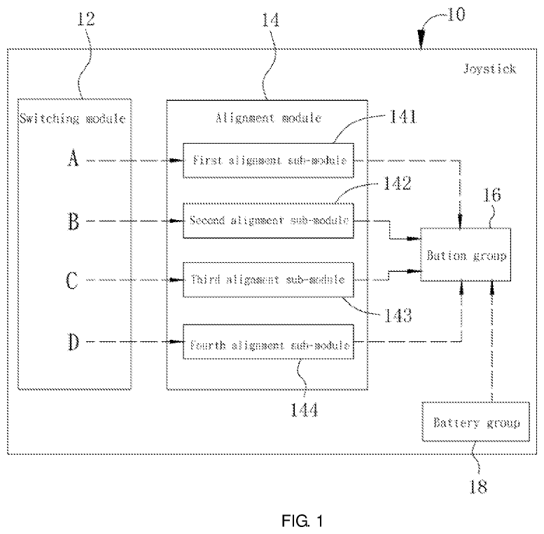

Please refer to FIG. 1, which is a schematic structural diagram of the joystick 10 of the present invention. In order to achieve at least one of the advantages or other advantages, an embodiment of the present invention provides a joystick 10. As shown in the figure, the joystick 10 includes a switching module 12, an alignment module 14 and a button group 16.

The switching module 12 is used to receive a switching instruction, and the switching instruction may be triggered by a user. In one embodiment, the switching module 12 is a hardware switching module 12, which can be implemented by a lever mechanical structure design or a multi-point button structure design. In the figure, four stages A, B, C, and D of the switching module 12 correspond to the different lever levels of the lever structure and the different key positions of the multi-point button structure.

The alignment module 14 is coupled to the switching module 12 and activates the alignment sub-modules within it, according to the switching instruction. In one embodiment, as shown in FIG. 1, the alignment module 14 includes a first alignment sub-module 141, a second alignment sub-module 142, a third alignment sub-module 143 and a fourth alignment sub-module 144. The first alignment sub-module 141, the second alignment sub-module 142, the third alignment sub-module 143 and the fourth alignment sub-module 144 are independent and not interfere with each other. According to the switching instruction, the alignment module 14 activates one of the first alignment sub-module 141, the second alignment sub-module 142, the third alignment sub-module 143 and the fourth alignment sub-module 144 corresponding to the switching instruction. For example, when the user selects the stage A by lever or clicking, the switching module 12 receives a switching instruction to switch to stage A, and sends the switching instruction to the alignment module 14, and then the alignment module 14 activates the alignment sub-module 141 corresponding to the stage A.

The button group 16 is coupled to the alignment module 14 and adjusted to a specific state according to the activated alignment sub-module. Continuing the above example, after the alignment module 14 activates the first alignment sub-module 141 corresponding to the stage A, the button group 16 will display the corresponding button positions and button types according to the activated first alignment sub-module 141 for the match with an equipment and thereby meet the needs of the user. In other words, the specific state refers to displaying the buttons corresponding to the activated alignment sub-module. The button group 16 can perform the display by means of an LED display module. For example, the specific state corresponding to the second alignment sub-module 142 is displayed as a PS4 game joystick, and its function buttons include triangles, circles, crosses, and squares. Now it is switched to the one corresponding to the third alignment sub-module and is displayed as the Switch joystick, then the function buttons are changed to X, A, B, and Y. In addition, if the original function buttons are 5 buttons, after switching to the specific state corresponding to the third alignment sub-module 143 and displaying the Switch joystick, the displayed function buttons will be adjusted to only display 4 buttons.

In particular, only one alignment sub-module will be activated at the same time, that is, in the process of switching from the activated first alignment sub-module 141 to activate the second alignment sub-module 142, the first alignment sub-module 141 will be deactivated first, and then the second alignment sub-module 142 will be activated thereby to avoid crash. In addition, in order to avoid the unexpected situations caused by switching too fast, the switching interval can be set, for example, 0.1 s.

In one embodiment, the first to the fourth alignment sub-modules 141 to 144 correspond to different modes. The first alignment sub-module may correspond to a first Bluetooth channel mode, the second alignment sub-module may correspond to a second Bluetooth channel mode, the third alignment sub-module may correspond to a Switch series mode and the fourth alignment sub-module may correspond to a shutdown mode. Among them, the bandwidths of the first and the second channels are different. The bandwidth of the first channel may be 2.4 GHz. The first alignment sub-module 141 may be used to support devices such as Tesla in-vehicle systems, desktop computers, and notebook computers. The second alignment sub-module 142 may be used to support devices such as Apple devices and Xbox. In addition, through the shutdown mode corresponding to the fourth alignment sub-module 144, the power can be saved, the overall standby time and the user's outdoor use time can be extended.

In one embodiment, the alignment module 14 may further include a fifth alignment sub-module (not shown), and the fifth alignment sub-module may correspond to the PS series mode to add more application scenarios.

In one embodiment, the joystick 10 may further include a battery module 18. The battery module 18 is connected to the button group 16 for providing power to the button group 16 so as to display the buttons. Furthermore, the battery module 18 may be a solar cell to enhance the overall use time.

In summary, by using the joystick 10 provided by the present invention, one-to-many application scenarios can be realized by the combination of the switching module 12, the alignment module 14 and the button group 16, that is, one joystick 10 can support the use of different scenarios such as Tesla in-vehicle systems, Apple devices, Xbox devices, Switch games, etc., to meet various user needs.

The foregoing contents are detailed description of the disclosure in conjunction with specific preferred embodiments and concrete embodiments of the disclosure are not limited to these descriptions. For the person skilled in the art of the disclosure, without departing from the concept of the disclosure, simple deductions or substitutions can be made and should be included in the protection scope of the application.

What is claimed is:

1. A joystick, comprising:
a switching module, receiving a switching instruction;
an alignment module, coupled to the switching module, activating an alignment sub-module within the alignment module according to the switching instruction; and
a button group, coupled to the alignment module, being adjusted to a specific state according to the activated alignment sub-module.

2. The joystick according to claim 1, wherein the alignment module comprises a first alignment sub-module, a second alignment sub-module, a third alignment sub-module and a fourth alignment sub-module, the first alignment sub-module, the second alignment sub-module, the third alignment sub-module and the fourth alignment sub-module are independent with each other, according to the switching instruction, the alignment module activates one of the first alignment sub-module, the second alignment sub-module, the third alignment sub-module and the fourth alignment sub-module corresponding to the switching instruction.

3. The joystick according to claim 2, wherein the first alignment sub-module, the second alignment sub-module, the third alignment sub-module and the fourth alignment sub-module correspond to different modes.

4. The joystick according to claim 3, wherein the first alignment sub-module corresponds to a first Bluetooth channel mode, the second alignment sub-module corresponds to a second Bluetooth channel mode, the third alignment sub-module corresponds to a Switch series mode and the fourth alignment sub-module corresponds to a shutdown mode.

5. The joystick according to claim 2, wherein the first alignment sub-module corresponds to a first Bluetooth channel mode, the second alignment sub-module corresponds to a second Bluetooth channel mode, the third alignment sub-module corresponds to a Switch series mode and the fourth alignment sub-module corresponds to a shutdown mode.

6. The joystick according to claim 2, wherein the alignment module further comprises a fifth alignment sub-module corresponding to a PS series mode.

7. The joystick according to claim 1, wherein the switching module receives the switching instruction through a lever or a click.

8. The joystick according to claim 1, wherein the specific state refers to displaying a button corresponding to the activated alignment sub-module.

9. The joystick according to claim 1, further comprising a battery module, coupled to the button group for providing power.

10. The joystick according to claim 9, wherein the battery module is a solar cell.
